(19) United States
(12) Patent Application Publication
(10) Pub. No.: US 2010/0130088 A1
(43) Pub. Date: May 27, 2010

(54) METHOD FOR MANUFACTURING PLASMA DISPLAY PANEL

(75) Inventors: Shinichiro Ishino, Osaka (JP); Koyo Sakamoto, Osaka (JP); Yuichiro Miyamae, Osaka (JP); Kaname Mizokami, Kyoto (JP); Yoshinao Ooe, Kyoto (JP)

Correspondence Address: WENDEROTH, LIND & PONACK L.L.P., 1030 15th Street, N.W., Suite 400 East, Washington, DC, 20005-1503, US

(73) Assignee: PANASONIC CORPORATION, OSAKA (JP)

(21) Appl. No.: 12/595,718

(22) PCT Filed: Apr. 6, 2009
(86) PCT No.: PCT/JP2009/001585

§ 371 Date: Oct. 13, 2009

(30) Foreign Application Priority Data
Apr. 9, 2008 (JP) 2008-101195

(51) Int. Cl. H01J 9/24

(52) U.S. Cl. 445/24

(57) ABSTRACT

A plasma display panel capable of displaying high definition at high luminance with lower power consumption is obtainable. Metal oxide paste formed of metal oxide particles, organic resin component, and diluting agent is painted on primary film (91), which is then fired, so that multiple metal oxide particles are attached to primary film (91). The metal oxide paste contains metal oxide particles not greater than 1.5 vol % and the organic resin component within a range from 8.0 to 20.0 vol %.

### TECHNICAL FIELD

The present invention relates to a method for manufacturing plasma display panels.

### BACKGROUND ART

A plasma display panel (hereinafter referred to simply as “PDP”), among other flat panel displays (FPD), allows achieving a high-speed display as well as a large-size display with ease. The PDP is thus commercialized in various fields such as video display devices and display devices for public communication.

In general, an AC-drive and surface discharge type PDP adopts 3-electrode structure, and is formed of two glass substrates, i.e. a front panel and a rear panel confronting each other with a given space between the front panel and the rear panel. The front panel includes display electrodes formed of scan electrodes and sustain electrodes, both of which are shaped like stripes and formed on one of the glass substrates, a dielectric layer covering the display electrodes and storing electric charges for working as a capacitor, and a protective film formed on the dielectric layer and having a thickness of approx. 1 μm. The rear panel includes multiple address electrodes formed on the other glass substrate, a primary dielectric layer covering the address electrodes, barrier ribs formed on the primary dielectric layer, and a phosphor layer painted onto display cells partitioned by the barrier ribs for emitting light in red, green and blue respectively.

The front panel confronts the rear panel such that its electrode-mounted surface confronts an electrode-mounted surface of the rear panel, and peripheries of both the panels are sealed in an airtight manner to form a discharge space between the front and rear panels, and the discharge space is partitioned by the barrier ribs. The discharge space is filled with discharge gas of Neon (Ne) and Xenon (Xe) at a pressure ranging from 53 kPa to 80.0 kPa. The PDP allows displaying a color video through this method: Voltages of video signals are selectively applied to the display electrodes for discharging, thereby producing ultra-violet rays, which excite respective colors of the phosphor layers, so that colors in red, green, and blue are emitted, thereby achieving the display of a color video (Refer to Patent Literature 1).

The protective layer formed on the dielectric layer of the front panel of the foregoing PDP is expected to carry out the two major functions: (1) protecting the dielectric layer from ion impact caused by the discharge, and (2) emitting primary electrons for generating address discharges. The protection of the dielectric layer from the ion impact plays an important role for preventing a discharge voltage from rising, and the emission of primary electrons for generating the address discharges also plays an important role for eliminating a miss in the address discharges because the miss causes flickers on videos.

To reduce the flickers on videos, the number of primary electrons emitted from the protective layer should be increased. For this purpose, silicon (Si) or aluminum (Al), for instance, is added to MgO.

In recent years, the number of high-definition TV receivers has increased, which requires the PDP to be manufactured at a lower cost, to consume a lower power, and to be a full HD (high-definition, 1920×1080 pixels, and progressive display) with a higher brightness. The characteristics of emitting electrons from the protective layer determine the picture quality, so that the control over the electron emission characteristics is vital for the picture quality.

A protective layer added with a mixture of impurities has been tested whether or not this addition can improve the electron-emission characteristics (refer to Patent Literature 2); however, when the characteristics can be improved by adding the impurity to the protective layer, electric charges are stored on the surface of the protective layer. If the stored electric charges are used as a memory function, the number of electric charges decreases greatly with time, i.e. an attenuation rate becomes greater. To overcome this greater attenuation, a measure is needed such as increment in an applied voltage. The protective layer thus should have two contradictory characteristics, i.e. one is a high emission of electrons, and the other one is a smaller attenuation rate for a memory function, namely, a high retention of electric charges.

Patent Literature 1: Unexamined Japanese Patent Publication No. 2007-48733

Patent Literature 2: Unexamined Japanese Patent Publication No. 2002-260535

### DISCLOSURE OF INVENTION

The present invention addresses the problem discussed above, and aims to provide a method for manufacturing the PDP comprising:
a front panel including a substrate on which display electrodes are formed, a dielectric layer covering the display electrodes, and a protective layer formed on the dielectric layer; and
a rear panel opposing to the front panel to form a discharge space therebetween, and including address electrodes formed along the direction intersecting with the display electrodes, and barrier ribs for partitioning the discharge space.

The protective layer is manufactured with the method comprising the steps of:
forming a primary film by depositing the primary film on the dielectric layer; and
forming particles of metal oxide by painting the metal oxide paste, which includes metal oxide particles, organic resin component and diluting agent, onto the primary film, and then firing the paste for attaching the multiple particles of the metal oxide to the primary film. The paste contains the particles of the metal oxide not greater than 1.5% volume content, and the organic resin component is contained within the range from 8.0 vol % to 20.0 vol %.

The structure discussed above allows the paste of metal oxide to attach the particles of the metal oxide discretely and uniformly onto the entire surface of the primary film, so that a uniform distribution of coverage with the particles over the entire surface is achievable. The paste is excellent in dispersion, printability, and flammability. As a result, the electron emission characteristics can be improved, and yet, the electric charge retention characteristics are maintained. The PDP having display performance of high definition and high brightness with less power consumption is thus obtainable.

### BRIEF DESCRIPTION OF DRAWINGS

FIG. 1 shows a perspective view illustrating a structure of a PDP in accordance with an embodiment of the present invention.

FIG. 2 shows a sectional view illustrating a structure of a front panel of the PDP shown in FIG. 1.

FIG. 3 shows a flowchart illustrating steps for forming a protective layer of the PDP.

FIG. 4 shows characteristics of the metal oxide paste employed in the method for manufacturing the PDP in accordance with the embodiment.

FIG. 5 shows cathode luminescence of crystal particles.

FIG. 6 shows a result of studying the relation between the characteristics of electron emission and the characteristics of Vscn lighting voltage.

FIG. 7 shows a relation between a diameter of a crystal particle and the electron emission characteristics of the PDP.

FIG. 8 shows a relation between a diameter of a crystal particle and a rate of occurrence of breakage in barrier ribs of the PDP.

FIG. 9 shows an example of particle size distribution of the aggregated particle of the PDP.

### REFERENCE SIGNS LIST

1 PDP
2 front panel
3 front glass substrate
4 scan electrode
4a, 5a transparent electrode
4b, 5b metal bus electrode
5 sustain electrode
6 display electrode
7 black stripe (lightproof layer)
8 dielectric layer
9 protective layer
10 rear panel
11 rear glass substrate
12 address electrode
13 primary dielectric layer
14 barrier rib
15 phosphor layer
16 discharge space
81 first dielectric layer
82 second dielectric layer
91 primary film
92 aggregated particle

### BEST MODE FOR CARRYING OUT THE INVENTION

An exemplary embodiment of the present invention is demonstrated hereinafter with reference to the accompanying drawings.

### Exemplary Embodiment

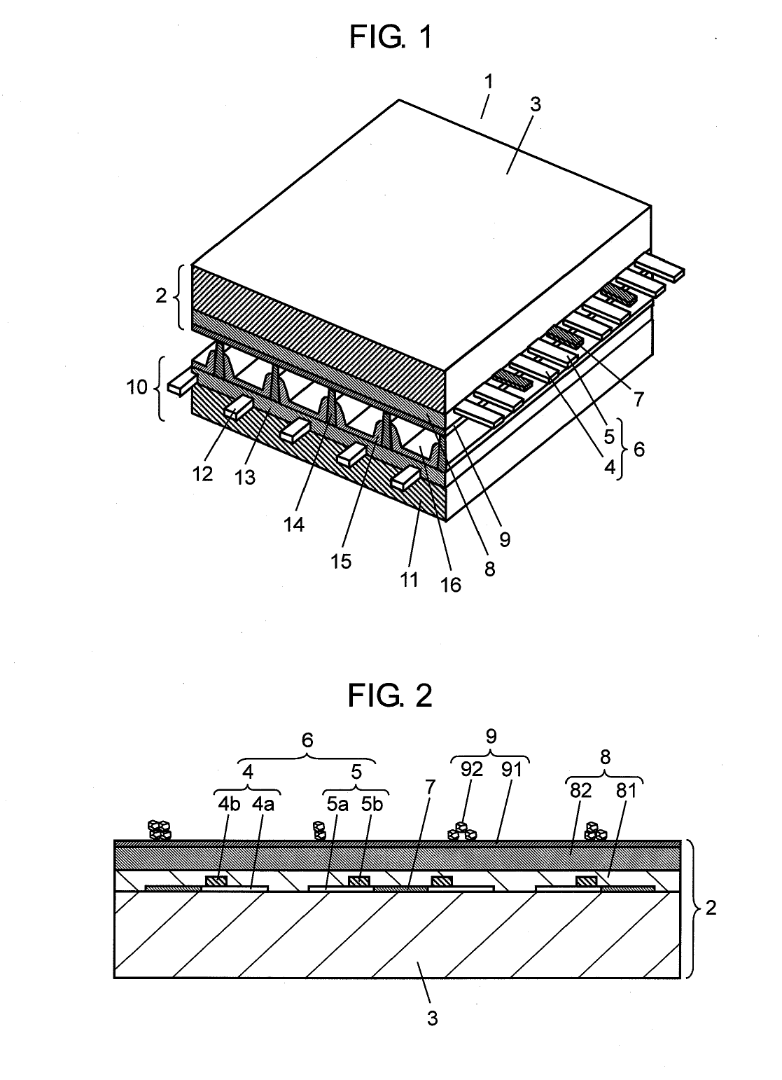

FIG. 1 shows a perspective view illustrating a structure of PDP 1 manufactured with a method in accordance with the embodiment of the present invention. PDP 1 is formed of front panel 2 including front glass substrate 3, and rear panel 10 including rear glass substrate 11. Front panel 2 and rear panel 10 confront each other and the peripheries thereof are airtightly sealed with sealing agent such as glass frit, thereby forming discharge space 16, which is filled with discharge gas of Ne and Xe at a pressure falling within a range between 53.3 kPa and 80.0 kPa.

Multiple pairs of belt-like display electrodes 6, each of which is formed of scan electrode 4 and sustain electrode 5, are placed in parallel with multiple black-stripes (lightproof layer) 7 on front glass substrate 3 of front panel 2. Dielectric layer 8 working as a capacitor is formed on front glass substrate 3 such that layer 8 can cover display electrodes 6 and lightproof layer 7. On top of that, protective layer 9 made of magnesium oxide (MgO) is formed on the surface of dielectric layer 8.

Multiple belt-like address electrodes 12 are placed in parallel with one another on rear glass substrate 11 of rear panel 10, and they are placed along a direction intersecting at right angles with scan electrodes 4 and sustain electrodes 5 formed on front panel 2. Primary dielectric layer 13 covers those address electrodes 12. Barrier ribs 14 having a given height are formed on primary dielectric layer 13 placed between respective address electrodes 12, and ribs 14 partition discharge space 16. Phosphor layers 15 are applied onto grooves formed between each one of barrier ribs 14 sequentially in response to respective address electrodes 12. Phosphor layers 15 emit light in red, blue, and green with an ultraviolet ray respectively. A discharge cell is formed at a junction point where scan electrode 4, sustain electrode 5 and address electrode 12 intersect with one another. The discharge cells having phosphor layers 15 of red, blue, and green respectively are placed along display electrodes 6, and these cells work as pixels for color display.

FIG. 2 shows a sectional view illustrating a structure of front panel 2 of PDP1 in accordance with this embodiment. FIG. 2 shows front panel 2 upside down from that shown in FIG. 1. As shown in FIG. 2, display electrode 6 formed of scan electrode 4 and sustain electrode 5 is patterned on front glass substrate 3 manufactured by the float method. Lightproof layer 7 is also patterned together with display electrode 6 on substrate 3. Scan electrode 4 is formed of transparent electrodes 4a, 5a made of indium tin oxide (ITO) or tin oxide (SnO₂), and sustain electrode 5 is formed of metal bus electrodes 4b, 5b formed on transparent electrodes 4a, 5a. Metal bus electrodes 4b, 5b give electrical conductivity to transparent electrodes 4a, 5a along the longitudinal direction of electrodes 4a, 5a, and they are made of conductive material of which chief ingredient is silver (Ag).

Dielectric layer 8 is formed of at least two layers, i.e. first dielectric layer 81 that covers transparent electrodes 4a, 5a and metal bus electrodes 4b, 5b and light proof layer 7 formed on front glass substrate 3, and second dielectric layer 82 formed on first dielectric layer 81.

The structure of protective layer 9, which features the present invention, is detailed hereinafter. As shown in FIG. 2, protective layer 9 of the PDP in accordance with this embodiment is formed this way: Primary film 91, made of magnesium oxide (MgO) or MgO containing aluminum (Al), is formed on dielectric layer 8, and aggregated particles 92 are dispersed discretely and almost uniformly on the entire surface of this primary film 91. Aggregated particle 92 is formed by aggregating multiple crystal particles made of metal oxide, i.e. MgO. The coverage with particles 92 over the surface of primary film 91 falls within the range from 2% to 12%.

The coverage in this context is expressed with this equation:

Coverage (%)=a/b×100

where “a” represents an area where aggregated particles 92 are attached within one discharge cell, and “b” represents an area of one discharge cell.

Actually the area can be measured this way: take a photo with a camera of an area of one discharge cell partitioned by barrier ribs 14, and then trim the photo into one cell in the dimension of x×y. Then binarize the photo having undergone the trimming into a binary image (data in black and white). Find the area “a”, i.e. black area occupied by aggregated particles 92, and find the coverage through the equation of coverage (%)=a/b×100.

A method for manufacturing the PDP is demonstrated hereinafter. First, form scan electrodes 4, sustain electrodes 5, and black stripes (lightproof layer) 7 on front glass substrate 3. Scan electrode 4 and sustain electrode 5 are respectively formed of transparent electrodes 4a, 5a and metal bus electrodes 4b, 5b. These transparent electrodes 4a, 5a, and metal bus electrodes 4b, 5b are patterned with a photo-lithography method. Transparent electrodes 4a, 5a are formed by using a thin-film process, and metal bus electrodes 4b, 5b are made by firing the paste containing silver (Ag) at a given temperature before the paste is hardened. Black stripes (lightproof layer) 7 is made by screen-printing the paste containing black pigment, or by forming the black pigment on the entire surface of the glass substrate, and then patterning the pigment with the photolithography method before the paste is fired.

Next, paint the dielectric paste onto front glass substrate 3 with a die-coating method such that the paste can cover display electrodes 6 formed of scan electrodes 4 and sustain electrodes 5, and black stripes (lightproof layer) 7, thereby forming a dielectric paste layer (dielectric material layer, not shown). Then fire and harden the dielectric paste layer for forming dielectric layer 8 which covers scan electrodes 4, sustain electrodes 5 and black stripes (lightproof layer) 7. The dielectric paste is a kind of paint containing binder, solvent, and dielectric material such as glass powder.

Next, form protective layer 9 made of magnesium oxide (MgO) on dielectric layer 8 with the vacuum deposition method. The foregoing steps allow forming predetermined structural elements (display electrodes 6, lightproof layer 7, dielectric layer 8 and primary film 91), except aggregated particle 92, on front glass substrate 3.

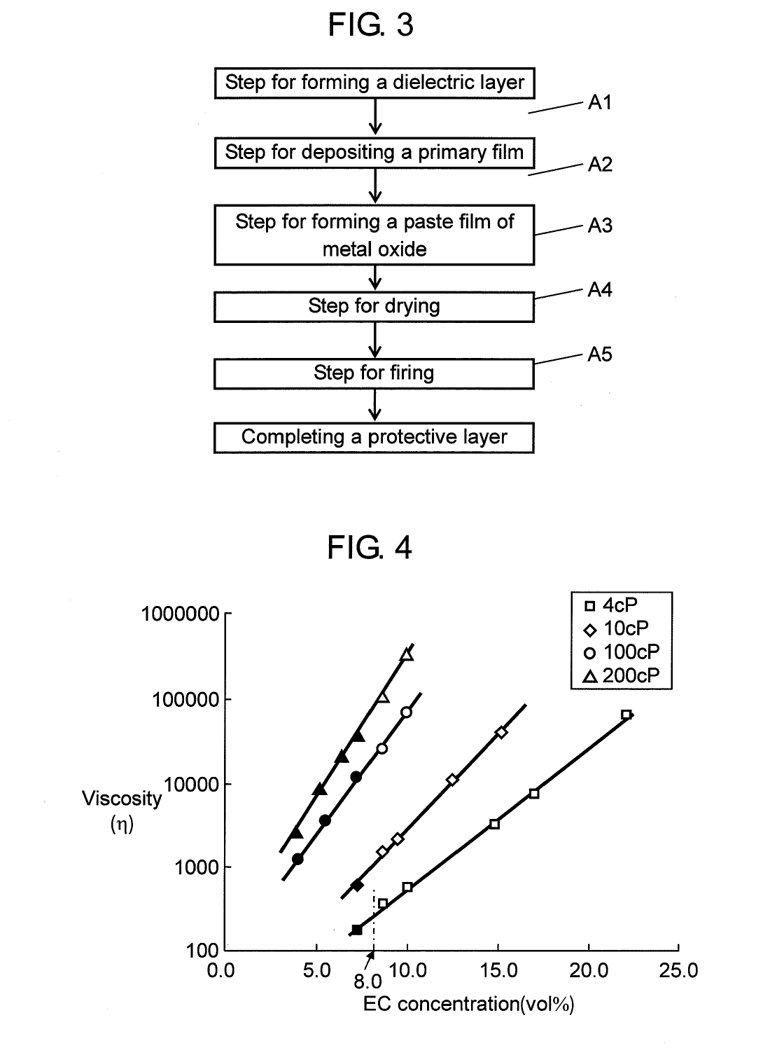

The steps for manufacturing protective layer 9 of PDP 1 are demonstrated hereinafter with reference to FIG. 3. As shown in FIG. 3, step A1 is done for forming dielectric layer 8, and then step A2 is done for depositing primary film 91 chiefly made of MgO on dielectric layer 8 with the vacuum deposition method by using sintered body of MgO containing some aluminum (Al).

Then attach discretely multiple aggregated particles 92 onto primary film 91 (step A3), which is formed in step A2 for depositing the primary film but is not yet fired. Particle 92 is to be metal oxide particles and is formed by aggregating crystal particles of MgO. In this step A3, prepare the paste by mixing aggregated particles 92 with organic resin component into diluting agent, and then, apply this paste onto non-fired primary film 91 with a screen printing method for forming the metal oxide film.

The metal oxide paste is detailed later. Instead of the screen printing method, a spraying method, spin-coating method, die-coating method, or slit-coating method can be used for painting this paste on non-fired primary film 91 to form the paste film.

The metal oxide paste film undergoes drying step A4. Then non-fired primary film 91 formed in step A2 and the paste film having undergone drying step A4 are fired together at several hundreds ° C. in firing step A5. In step A5, solvent and resin component remaining in the paste film are removed, so that protective layer 9, of which primary film 91 is attached with multiple aggregated particles 92, is completed. Step A3 for forming the film of metal oxide paste, step A4 for drying, and step A5 for firing are the steps for forming the particles of the metal oxide.

In the foregoing discussion, primary film 91 chiefly made of MgO is used; however, according to the present invention, film 91 must withstand intensive sputtering because it should protect dielectric layer 9 from ion-impact, so that it is not necessarily to have high electron emission capability. In other words, a conventional PDP employs a protective layer formed of a primary film chiefly made of MgO in order to satisfy both of the electron emission performance and withstanding performance to the sputtering at a certain level or higher than the certain level. The PDP of the present invention, however, employs the primary film attached with crystal particles of metal oxide onto the film, and crystal particles of the metal oxide dominantly control the electron emission performance. Primary film 91, therefore, is not necessarily made of MgO, but other materials more excellent in resistance to sputtering, such as Al₂O₃, can replace MgO.

In this embodiment, MgO particles are used as crystal particles of metal oxide; however, other crystal particles of metal oxide such as strontium (Sr), calcium (Ca), barium (Ba), and aluminum (Al) can replace MgO as long as they have the electron emission performance as high as MgO. Use of these metal oxides can also achieve similar advantages to the foregoing ones. A material of crystal particle is thus not limited only to MgO.

The steps discussed above allow forming such structural elements on front glass substrate 3 as display electrodes 6, black stripes (lightproof layer) 7, dielectric layer 8, primary film 91, and aggregated particles 92 made of MgO.

Rear panel 10 is formed this way: First, form a material layer, which is a structural element of address electrode 12, by screen-printing the paste containing silver (Ag) onto rear glass substrate 11, or by patterning with the photolithography method a metal film which is formed in advance on the entire surface of rear glass substrate 11. Then fire this material layer at a given temperature, thereby forming address electrodes 12. Next, form a dielectric paste layer (not shown) on rear glass substrate 11, on which address electrodes 12 are formed, by painting dielectric paste onto substrate 11 with the die-coating method such that the dielectric paste layer can cover address electrodes 12. Then fire the dielectric paste layer for forming primary dielectric layer 13. The dielectric paste is a kind of paint containing binder, solvent, and dielectric material such as glass powder.

Next, paint the paste containing the material for barrier rib 14 onto primary dielectric layer 13, and pattern the paste into a given shape, thereby forming a barrier-rib material layer. Then fire this barrier-rib material layer for forming barrier ribs 14. The photolithography method or a sand-blasting method can be used for patterning the paste painted on primary dielectric layer 13. Next, paint the phosphor paste containing phosphor material onto primary dielectric layer 13 surrounded by barrier ribs 14 adjacent to one another and also onto lateral walls of barrier ribs 14. Then fire the phosphor paste for forming phosphor layer 15. The foregoing steps allow completely forming rear panel 10 including the predetermined structural elements on rear glass substrate 11.

Front panel 2 and rear panel 10 discussed above are placed opposite to each other such that display electrodes 6 intersect at right angles with address electrodes 12, and the peripheries of panel 2 and panel 10 are sealed with glass frit to form discharge space 16 between panels 2 and 10, and space 16 is filled with discharge gas including Ne, Xe. PDP 1 is thus completed.

The paste of metal oxide, used for forming a layer attached with crystal particles of the metal oxide onto primary film 91, is detailed hereinafter. This layer is formed on primary film 91 in step A3 for forming the paste film of the metal oxide of the PDP manufactured with the method of the present invention. The description focuses on the experiment on ascertaining the advantage of volume and stable production of the paste. In the following discussion, various chemicals are used; however, they and their numerical conditions such as amounts are examples within the scope of the present invention, so that the present invention is not limited to these examples.

The material formed of compositions listed in tables 1 and 2 is blended with a three-roll mill.

Considering the discharge characteristics of the PDP, the coverage with aggregated particles 92 made of MgO over primary film 91 preferably falls within the range from 2% to 12%. Since the coverage is determined by a thickness of the film of metal-oxide paste, the content of aggregated particles 92 made of MgO in the metal oxide paste preferably falls within the range from 0.01 vol % to 1.5 vol % based on the film thickness printable with the screen printing method.

The numerical values in TABLEs 1 and 2 are expressed in vol %.

TABLE 1

| | | Composition No. | | | | | | | | | | |
|---|---|---|---|---|---|---|---|---|---|---|---|---|
| | | 101 | 102 | 103 | 104 | 105 | 106 | 107 | 108 | 109 | 110 | 111 |
| Metal | MgO | 0.20 | 0.20 | 0.20 | 0.20 | 0.20 | 0.20 | 0.20 | 0.20 | 0.20 | 0.20 | 0.20 |
| oxide | particle | | | | | | | | | | | |
| Organic | Ethyl- | 7.21 | 8.64 | 9.96 | 14.76 | 17.09 | 22.11 | — | — | — | — | — |
| resin | cellulose | | | | | | | | | | | |
| compo- | 4 cP | | | | | | | | | | | |
| nent | Ethyl- | — | — | — | — | — | — | 7.21 | 8.64 | 9.46 | 12.47 | 15.16 |
| | cellulose | | | | | | | | | | | |
| | 10 cP | | | | | | | | | | | |
| Diluting | Butyl | 68.93 | 67.86 | 66.88 | 63.31 | 61.57 | 57.84 | 68.93 | 67.86 | 67.25 | 65.01 | 63.01 |
| agent | carbitol | | | | | | | | | | | |
| | Terpinol | 23.66 | 23.30 | 22.96 | 21.73 | 21.14 | 19.85 | 23.66 | 23.30 | 23.09 | 22.32 | 21.63 |

| | | | | | | | | | | | |
|---|---|---|---|---|---|---|---|---|---|---|---|
| Total | 100.00 | 100.00 | 100.00 | 100.00 | 100.00 | 100.00 | 100.00 | 100.00 | 100.00 | 100.00 | 100.00 |

TABLE 2

| | | Composition No. | | | | | | | | | | |
|---|---|---|---|---|---|---|---|---|---|---|---|---|
| | | 112 | 113 | 114 | 115 | 116 | 117 | 118 | 119 | 120 | 121 | 122 |
| Metal | MgO | 0.20 | 0.20 | 0.20 | 0.20 | 0.20 | 0.20 | 0.20 | 0.20 | 0.20 | 0.20 | 0.20 |
| oxide | particle | | | | | | | | | | | |
| Organic | Ethyl- | 4.00 | 5.41 | 7.21 | 8.64 | 9.96 | — | — | — | — | — | — |
| resin | cellulose | | | | | | | | | | | |
| compo- | 100 cP | | | | | | | | | | | |
| nent | Ethyl- | — | — | — | — | — | 3.81 | 5.15 | 6.31 | 7.21 | 8.64 | 9.96 |
| | cellulose | | | | | | | | | | | |
| | 200 cP | | | | | | | | | | | |
| Diluting | Butyl | 71.32 | 70.27 | 68.93 | 67.86 | 66.88 | 71.46 | 70.46 | 69.60 | 68.93 | 67.86 | 66.88 |
| agent | carbitol | | | | | | | | | | | |
| | Terpinol | 24.48 | 24.12 | 23.66 | 23.30 | 22.96 | 24.53 | 24.19 | 23.89 | 23.66 | 23.30 | 22.96 |

| | | | | | | | | | | | |
|---|---|---|---|---|---|---|---|---|---|---|---|
| Total | 100.00 | 100.00 | 100.00 | 100.00 | 100.00 | 100.00 | 100.00 | 100.00 | 100.00 | 100.00 | 100.00 |

Composition Nos. 101-111 listed in table 1 show the viscosity (cP) of 4 cP and 10 cP due to difference in molecular weight grade of ethyl-cellulose, and composition Nos. 112-122 show the viscosity (cP) of 100 cP and 200 cP due to difference in molecular weight grade of ethyl-cellulose.

The organic resin components listed in tables 1 and 2 employ ethyl-cellulose; however, cellulose derivatives other than ethyl-cellulose such as hydroxypropyl cellulose, hydroxyethyl cellulose, hydroxypropyl methylcellulose phtalate, hydroxypropyl methylcellulose acetate can be employed.

Other than the foregoing cellulose derivatives, the chemical compounds listed below can be also used: acrylic acid, methacrylic acid, methyl acrylate, methyl methacrylate, ethyl acrylate, ethyl methacrylate, butyl acrylate, butyl methacrylate, isobutyl acrylate, isobutyl methacrylate, mono-methyl fumarate, mono-ethyl fumarate, mono-propyl fumarate, mono-methyl maleate, mono-ethyl maleate, mono-propyl maleate, sorbic acid, hydroxymethyl acrylate, 2-hydroxyethyl acrylate, 2-hydroxymethyl methacrylate, 2-hydroxypropyl methacrylate, hydroxyl mono-acrylate, hydroxy mono-methacrylate, diacrylate hydroquinone, hydroquinone 2-dihydroxyl ethyl acrylate, 2-hydroxyethyl methacrylate, N-butyl acrylate, N-butylmethacrylate, isobutyl methacrylate, isobutyl acrylate, 2-ethyl hexylarylate, 2-ethyl hexylmethacrylate, benzylacrylate, benzylmethacrylate, phenoxy-methacrylate, phenoxyacrylate, isobornyl acrylate, isobornyl methacrylate, ethylene glycol dimethacrylate, triethylene glycol diacrylate, triethylene glycol dimethacrylate, tetraethylene glycol diacrylate, tetraethylene glycol dimethacrylate, butylene glycol dimethacrylate, propylene glycol diacrylate, propylene glycol dimethacrylate, trimethylolethane triacrylate, trimethylolethane trimethacrylate, trimethylolpropane triacrylate, trimethylolpropane trimethacrylate, tetramethylolpropane tetracrylate, tetramethylol-propane tetramethacrylate, 1.6-hexanediol diacrylate, 1.6-hexanediol dimethacrylate, cardo epoxy diacrylate, glycidyl methacrylate, and glycyl methacrylate ethylene glycol diacrylate.

Acrylate or methacrylate of the foregoing chemical compounds can be replaced with fumaric acid, i.e. fumarate, replaced with maleic acid, i.e. maleate, replaced with crotonic acie, i.e. crotonate, or replaced with itaconic acid, i.e. itaconate, or polymer or copolymer such as urethane methacrylate, styrene, acrylamide, methacrylamide, acrylonitrile, methacrylonitrile.

Those acrylic resin can be used alone, or can be combined with cellulose derivatives.

In tables 1 and 2, diethylene glycol monobutyl ether (butyl carbitol) and terpinol are used as diluting agent; however, other chemicals as follows can be used alone, or two or more than two chemicals below can be combined together for replacing butyl carbitol and terpinol:

ethylene glycol mono-methyl ether, ethylene glycol mono-ethyl ether, propylene glycol mono-methyl ether, propylene glycol mono-ethyl ether, diethylene glycol mono-methyl ether, diethylene glycol mono-ethyl ether, diethylene glycol dimethyl ether, diethylene glycol diethyl ether, propylene glycol mono-methyl ether acetate, propylene glycol mono-ethyl ether acetate, 2-methoxybutyl acetate, 3-methoxybutyl acetate, 4-methoxybutyl acetate, 2-methyl-3-methoxybutyl acetate, 3-methyl-3-methoxybutyl acetate, 3-ethyl-3-methoxybutyl acetate, 2-ethoxybutyl acetate, 4-ethoxybutyl acetate, 4-propoxybutyl acetate, 2-methoxypentyl acetate.

The paste can contain, upon necessity, plasticizer such as dioctyl phthalate, dibutyl phthalate, triphenyl phosphate, tributyl phosphate, and dispersant such as glycerop mono-oleate, sorbitan sesquio-leate, homogenol (a product manufactured by Kao Corporation), alkyl-allyl based phosphate.

The metal oxide pastes each of which is formed of composition No. 101-122 respectively are painted on front glass substrate 3, where display electrodes 6, black stripes (lightproof layer) 7, dielectric layer 8, and primary film 91 are formed, with the screen printing method in order to test the respective pastes for printability. The screen printing employs L380S mesh as a screen.

FIG. 4 shows the test result, namely, the characteristics of the metal oxide pastes employed in the method for manufacturing the PDP in accordance with the embodiment of the present invention. The horizontal axis of FIG. 4 represents the content (EC concentration) of ethyl-cellulose, i.e. organic resin component contained in the paste, and the vertical axis represents the viscosity “η” that is measured with Reo-Stress RS600 (made by Hakke Co., Ltd.) at a shear rate of D=1(1/s) per hour.

The test for the printability is done through eye observation to find knocking during the printing. A paste accompanied by knocking is marked in black, and a paste free from knocking is marked in white. The knocking in this context refers to “bit-by-bit vertical motion” of a squeegee on the mesh. The squeegee should move on the mesh smooth, but in this case, it somehow scratches on the mesh and vibrates vertically.

FIG. 4 also shows viscosities (cP), differing in molecular weight grades of the ethyl-cellulose, as parameters. As FIG. 4 explicitly depicts, when the content of ethyl-cellulose contained in the metal oxide paste is less than 8 vol %, knocking is observed regardless of the viscosity depending on the molecular weight grades.

These phenomena teach that frictional resistance between the screen (mesh) and the squeegee used in the screen printing depends much on the amount of organic resin component contained in the paste rather than the viscosity of the paste. Some dielectric paste available on the market is used for this purpose. It contains organic resin component 5 vol %, and also contains inorganic component, represented by the metal oxide contained in this dielectric paste, not less than 1.5 vol %, which reduces the frictional resistance between the mesh and the squeegee.

The coverage with aggregated particles 92 over front glass substrate 3 accompanied by the knocking is measured to find a dispersion of over 10% within an area, while a coverage over substrate 3 free from the knocking measures as good as not greater than 6% within the area. The dispersion within the area in this context is found this way:

Dispersion of the coverage within the area=σ/M×100(%),

where the coverage is measured at 54 points within the area, σ=standard deviation, and M=mean value.

The foregoing discussion proves that the organic resin component greater than 8 vol % contained in the metal oxide paste allows excellent printing free from knocking during the screen printing, where the metal oxide paste contains metal oxide particles not greater than 1.5 vol %.

On the other hand, as shown in FIG. 3, during the steps for manufacturing protective layer 9, the organic resin component contained in the metal oxide paste is removed in firing step A5 after step A3 (forming the paste film) and drying step A4. In step A5, a greater amount of the organic resin component contained in the paste will increase an amount of residual after the firing. As a result, a completed PDP still carries some residual, which adversely affects the discharge characteristics.

The experiment and the test teach the inventors that the organic resin component not greater than 20 vol % in the metal oxide paste allows the residual of the organic resin component not to adversely affect the discharge characteristics of PDP.

It is thus concluded that use of the metal oxide paste having the following structure allows manufacturing PDPs excellent in printability and free from degradation in the discharge characteristics caused by the residual of the organic resin component after the firing: The metal oxide paste is formed of the metal oxide particles, the organic resin component, and the diluting agent, and the paste contains the metal oxide particles not greater than 1.5 vol % and the organic resin component falling within the range from 8.0 to 20.0 vol %.

Next, the performance of PDP 1 is compared with those of other samples. This experiment is described hereinafter. PDP 1 is produced with the method for manufacturing PDPs in accordance with the embodiment of the present invention.

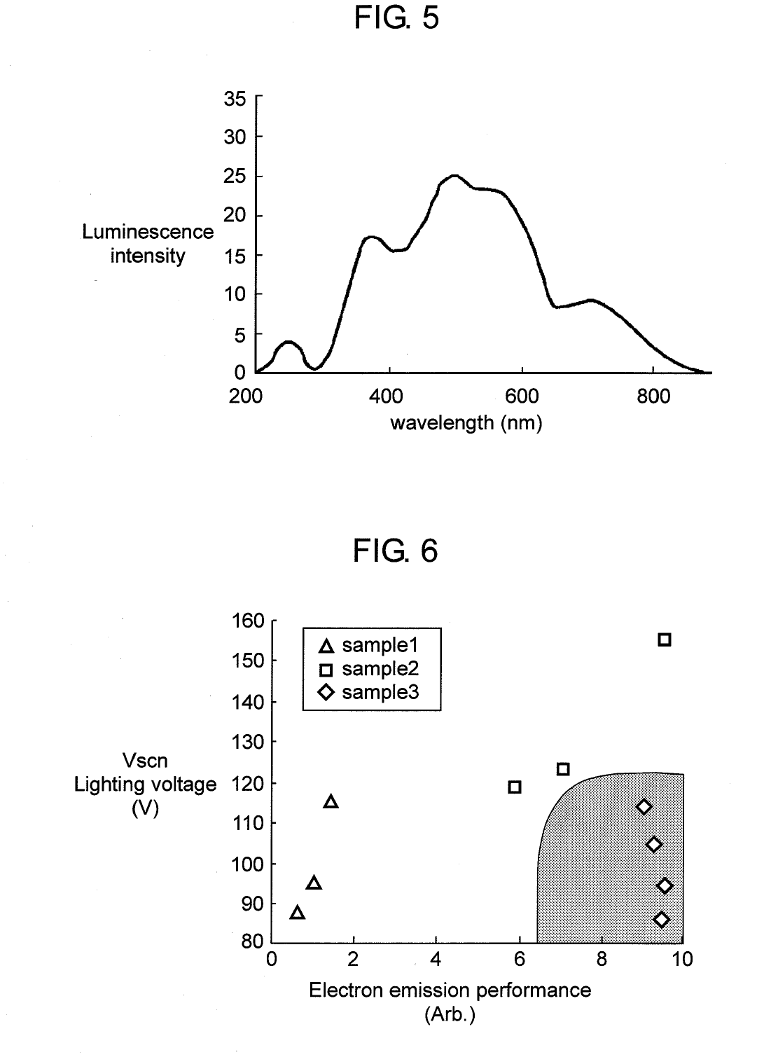

First, samples of PDP having different structures in the protective layer 9 are prepared. Sample 1 is a PDP of which protective layer 9 is formed of the film made of only MgO. Sample 2 is a PDP of which protective layer 9 is formed of MgO into which impurity such as aluminum (Al) or silicon (Si) is doped. Sample 3 is PDP 1 in accordance with the embodiment of the present invention. This PDP 1, i.e. sample 3 includes protective layer 9 having primary film 91 made of MgO, and aggregated particles 92, formed by aggregating multiple crystal particles of metal oxide, are uniformly distributed and attached on the entire surface of film 91. Cathode luminescence of the single crystal particle employed in sample 3 is measured to find the characteristics as shown in FIG. 5.

Those three samples of PDP having different structures from one another in protective layer 9 are tested for the electron emission performance and the electric charge retention performance.

The electron emission performance is a numerical value, i.e. a greater value indicates a greater amount of electron emitted, and is expressed with an amount of primary electron emitted, which is determined by a surface condition and a type of gas. The amount of primary electron emitted can be measured with a method that is used for measuring an amount of electron-current emitted from the surface of protective layer 9 through irradiating the surface with ions or an electron beam. However, it is difficult to test the surface of front panel 2 with a non-destructive examination. The evaluation method disclosed in Unexamined Japanese Patent Publication No. 2007-48733 is thus employed to measure a discharge delay (“ts” value) as the electron emission performance. In other words, a statistical delay time, which is a reference to the easiness of discharge occurrence, among delay times in discharge is measured. This reference number is inversed, and then integrated, thereby obtaining a value which linearly corresponds to the amount of emitted primary electrons, so that the value is used for the test. The delay time in discharge expresses the time of discharge delay (hereinafter referred to as “ts” value) from the pulse rising, and the discharge delay is chiefly caused by the struggle of the initial electrons, which trigger off the discharge, for emitting from the surface of the protective layer into the discharge space.

The electric charge retention performance is expressed with a voltage value applied to scan electrodes (hereinafter referred to as a “Vscn” lighting voltage), which is needed for suppressing an electron emission phenomenon of PDP1. To be more specific, higher electric charge retention performance can be expected at a lower Vscn lighting voltage, so that a lower Vscn voltage allows the PDP to be driven at a lower voltage design-wise. As a result, the power supply and electric components with a smaller withstanding voltage and a smaller capacity can be employed. In the existing products, semiconductor switching elements such as MOSFET are used for applying a scan voltage sequentially, and these switching elements have approx. 150V as a withstanding voltage. The Vscn lighting voltage is thus preferably lowered to not greater than 120V in the environment of 70° C. taking it into consideration that some change can occur due to variation caused by temperature.

FIG. 6 shows the relation between the electron emission performance and the electric charge retention performance. The horizontal axis of FIG. 6 represents the electron emission performance, and the test result of sample 1 is shown as a reference value. As FIG. 6 explicitly depicts, sample 3 can achieve controlling the Vscn lighting voltage to be not greater than 120V in the electric charge retention test, and yet, it can achieve approx. six times or more as good as sample 1 in the electron emission performance. Sample 3 includes, as described previously, aggregated particles 92 each of which is formed by aggregating multiple crystal particles of MgO, and particles 92 are uniformly distributed on the surface of primary film 91 made of MgO.

In general, the electron emission capability and the electric charge retention capability of protective layer 9 of PDP 1 conflict with each other. For instance, a change in film-forming condition of protective layer 9, or doping an impurity such as Al, Si, or Ba into protective layer 9 of sample 2 during the film-forming process, will improve the electron emission performance; however, the change or the doping will raise the Vscn lighting voltage as a side effect.

The present invention, however, allows obtaining protective layer 9 which can satisfy both of the electron emission capability and the electric charge retention capability appropriate to the PDP which is required to display an increased number of scanning lines as well as to have the smaller size cells due to the advent of high definition display.

Next, a particle diameter of the crystal particles employed in sample 3 is described hereinafter. The particle diameter refers to an average particle diameter, which means a volume cumulative average diameter (D50).

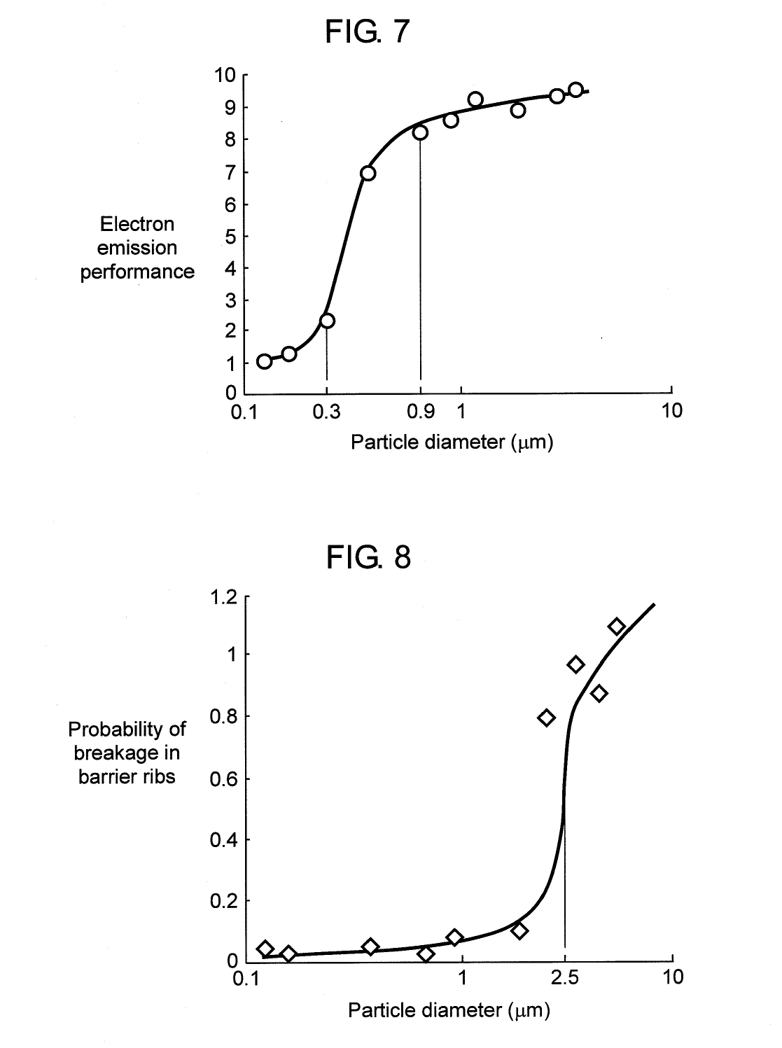

FIG. 7 shows a test result of sample 3 described in FIG. 6, and the test is done for the electron emission performance by changing a particle diameter of the crystal particle of MgO. In FIG. 7, the diameter of the crystal particle of MgO shows an average diameter measured with the micro-track HRA particle-size distribution meter in ethanol solution of the first grade reagent defined by JIS or the higher grade of the reagent, and the crystal particle is observed in SEM photo to be measured.

As shown in FIG. 7, the particle diameter as small as 0.3 μm results in the lower electron emission performance, while the particle diameter as great as 0.9 μm or more results in the higher electron emission performance.

A greater number of crystal particles per unit area on protective layer 9 is preferable for increasing the number of emitted electrons within a discharge cell. However, the experiment teaches the inventors the following fact: presence of the crystal particles at the top of barrier rib 14, with which protective layer 9 of front panel 2 closely contacts, breaks the top of barrier rib 14, and then the material of rib. 14 falls on phosphor layer 15, so that the cell encountering this problem cannot normally go on or go out. This breakage in the barrier ribs resists occurring when the crystal particles do not exist at the top of barrier rib 14, so that a greater number of the crystal particles will increase the occurrence of breakage in barrier ribs 14.

FIG. 8 shows relations between the particle diameter of the crystal particle and the breakage in barrier rib 14. The same numbers of the crystal particles per unit area although they have different diameters are sprayed in sample 3. As FIG. 8 explicitly depicts, the probability of breakage in barrier ribs 14 sharply increases when the diameter of the crystal particle becomes as large as 2.5 μm; however, it stays at a rather low level when the diameter stays not greater than 2.5 μm.

The forgoing result tells that aggregated particle 92 preferably has a particle diameter within a range from 0.9 μm to 2.5 μm. However, it is necessary to consider a dispersion of crystal particles in manufacturing and a dispersion of protective layers 9 in manufacturing.

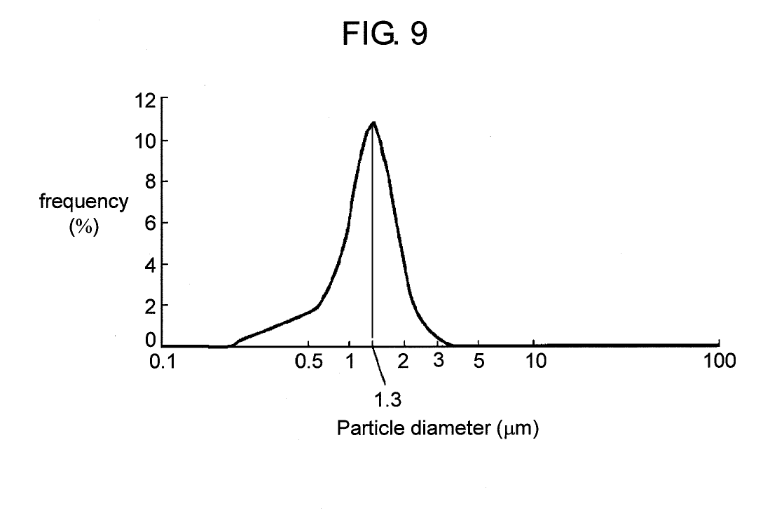

FIG. 9 shows an instance of particle size distribution of aggregated particle 92 employed in PDP1 of the present invention. Aggregated particle 92 has the particle size distribution as shown in FIG. 9, and the electron emission characteristics shown in FIG. 7 and barrier-rib breakage characteristics shown in FIG. 8 teach that it is preferable to use the aggregated particles, of which average particle diameter, i.e. volume cumulative average diameter (D50), falls within a range from 0.9 μm to 2 μm.

As discussed above, PDP 1 having protective layer 9 formed of metal oxide in accordance with this embodiment achieves electron emission capability more than six times as good as the protective layer formed of the primary film made of only MgO, and also achieves the electric charge retention capability such as the Vscn lighting voltage not greater than 120V. As a result, PDP1 thus can satisfy both of the electron emission capability and the electric charge retention capability, although PDP1 is to display an increased number of scanning lines as well as to have the smaller size cells due to the advent of high definition display. The PDP, which can display a high definition video at high luminance with lower power consumption, is thus obtainable.

In PDP 1 of the present invention, aggregated particles 92 formed of crystal particles of MgO are distributed and attached onto the entire surface of primary film 91 with the coverage ranging from 2% to 12%. This coverage range derives from the experiments for characteristics of the samples each of which coverage with aggregated particles 92 over primary film 91 differs from one another. To be more specific, the experiments prove that the Vscn lighting voltage rises at a greater coverage with aggregated particles 92, so that the electric charge retention capability degrades. To the contrary, the Vscn lighting voltage lowers at a smaller coverage. The experiments teach the inventors that the coverage not greater than 12% can take full advantage of aggregated particles 92 attached onto the surface of primary film 91.

Aggregated particles 92 of MgO, on the other hand, are needed in each one of the discharge cells for reducing the dispersion of the characteristics. Aggregated particles 92 should be thus attached on the surface of primary film 91. A smaller coverage with particles 92 thus tends to increase the dispersion on the surface, and an amount of particles 92 attached to each discharge cell differs greatly between the cells. The experiments also teach the inventors that the attachment of particles 92 formed of crystal particles of MgO at the coverage of 4% or more allows reducing the dispersion to approx. not greater than 4%, and the attachment of particles 92 at the coverage of 2% or more allows reducing the dispersion to approx. at 6%, which causes practically no problem.

Based on the foregoing results, it is concluded that aggregated particles 92 formed of crystal particles of MgO are preferably attached to primary film 91 at the coverage ranging from 2% to 12%, and more preferably, the coverage ranges from 4% to 12%.

### INDUSTRIAL APPLICABILITY

The present invention is useful for providing a PDP capable of displaying high definition at high luminance with lower power consumption.

1. A method for manufacturing a plasma display panel that comprises:
a front panel including a dielectric layer for covering display electrodes formed on a substrate, and a protective layer formed on the dielectric layer; and
a rear panel confronting the front panel for forming a discharge space between the front panel and the rear panel, and including address electrodes along a direction intersecting with the display electrodes, and barrier ribs for partitioning the discharge space,
the method comprising the step of:
forming the protective layer of the front panel, and this step including the steps of:
forming a primary film by depositing the primary film on the dielectric layer; and
forming metal oxide particles by painting metal oxide paste, which contains the metal oxide particles, organic resin component and diluting agent, onto the primary film, and then firing the metal oxide paste for attaching a plurality of the metal oxide particles to the primary film,
wherein, the metal oxide paste contains the metal oxide particles not greater than 1.5% volume content, and the organic resin component within a range from 8.0 to 20.0% volume content.

2. The method of claim 1, wherein the metal oxide paste contains the metal oxide particles not less than 0.01% volume content.

3. The method of claim 1, wherein the metal oxide particles are painted with a screen printing method.
